(19) United States
(12) Patent Application Publication
(10) Pub. No.: US 2014/0363364 A1
(43) Pub. Date: Dec. 11, 2014

(54) METHOD AND SYSTEM FOR PURIFICATION OF PRODUCED WATER

(71) Applicants: Dennis Sogaard, Struer (DK); PURETEQ A/S, Svendborg (DK)

(72) Inventor: Dennis Søgaard, Struer (DK)

(73) Assignee: PURETEQ A/S, Svendborg (DK)

(21) Appl. No.: 14/370,583

(22) PCT Filed: Jan. 7, 2013
(86) PCT No.: PCT/EP2013/050143

§ 371 Date: Jul. 3, 2014

(30) Foreign Application Priority Data
Jan. 6, 2012 (EP) 12150365.0

(51) Int. Cl. C02F 1/52; C01B 5/00

(52) U.S. Cl. CPC C02F 1/529; C02F 1/5281; C01B 5/00; C02F 2101/30
USPC 423/580.1; 210/721; 210/712; 210/709; 210/205; 210/207; 210/208; 210/170.01

(57) ABSTRACT

The present invention relates to a method for purification of produced water and to a system for carrying out the inventive method. Further, the invention relates to a purified produced water product obtainable according to the invention. A unique sequence of unit operations including the addition of dissolved calcium hydroxide and the subsequent precipitation thereof enable a particularly efficient removal of contaminating substances from produced water from the petrochemical industry.

### TECHNICAL FIELD

The present invention relates to a method for purification of produced water, in particular removal of organic substances from produced water and to a system for carrying out the inventive method.

### BACKGROUND

The oil industry produces around 2.5 times more water than oil. This water is produced as an aqueous process fluid, e.g. during offshore oil recovery. Such water is known in the art as “produced water”. Large amounts of produced water are also produced during onshore oil recovery.

The term “produced water” is well known in the art and refers to a range of various types of water depending on the origin of the produced water. However, produced water typically contains high concentrations of dissolved organic compounds such as e.g. crude oil as well as other bioaccumulative and/or toxic substances. Organic constituents are normally either dispersed or dissolved in produced water and include a number of dissolved compounds. Hydrocarbons occurring naturally in produced water include polycyclic aromatic hydrocarbons (PAHs), phenols, and volatiles. These hydrocarbons are probable contributors to produced water toxicity. In particular, PAHs increase biological oxygen demand and are potentially carcinogenic and mutagenic. Dissolved aromatic hydrocarbons and phenols have been found to contribute considerably to the toxicity of produced water from the oil industry.

Consequently, by the term “produced water” is meant an aqueous fluid comprising water in an amount of about 99% to nearly 100% and which further comprises at least one or more of benzene in an amount of about less than or equal to 0.01%, crude oil in an amount of about less than or equal to 0.01%, toluene in an amount of about less than or equal to 0.01%, ethyl benzene in an amount of about less than or equal to 0.01%, xylene in an amount of about less than or equal to 0.01%, hydrogen sulphide gases in an amount of about less than or equal to 0.01%. Produced water may further comprise dissolved minerals or metals such as e.g. sodium chloride and/or Lead (Pb), Cadmium (Cd), Chrome (Cr), Copper (Cu), Mercury (Hg), Nickel (Ni) and Zinc (Zn).

In this respect, it is important to understand that the term “produced water” as used herein is not equivalent with e.g. “waste water”. The difference is that waste water is water added to a process, whereas produced water is water that is water already present in a process, such as e.g. in extracting oil from an oil well, where water is present when the raw material is being pumped from the oil well. This also has the important implication that in principle, waste water can contain any other elements (apart from water) depending on the process in which the water was added. Moreover, in waste water, bioaccumulative components are not present, such as e.g. C₁₀ to C₃₅ organic components.

In general, the concentration of a particular organic compound in produced water increases when the molecular weight of the compound decreases. Organic components that are very soluble in produced water consist of low molecular weight (C₂-C₅) carboxylic acids (fatty acids), ketones, and alcohols. They include acetic and propionic acid, acetone, and methanol. In some produced waters, the concentration of these components is greater than 5,000 ppm. Soluble organic compounds are not easily removed from produced water. Therefore, (contaminated) produced water is typically reinjected to the oil deposit or discharged into the environment, i.e. the ocean on offshore locations.

Partially soluble components include medium to higher molecular weight hydrocarbons (C₆ to C₁₆). They are soluble in water at low concentrations, but are not as soluble as lower molecular weight hydrocarbons. They are not easily removed from produced water and are generally discharged directly into the ocean. They contribute to the formation of sheen, but the primary concern involves toxicity. These components include aliphatic and aromatic carboxylic acids, phenols, and aliphatic and aromatic hydrocarbons. PAHs are hydrocarbon molecules with several cyclic rings formed naturally from organic material under high pressure. PAHs are present in crude oil.

PAHs range from relatively “light” substances with average water solubility to “heavy” substances with high liposolubility and poor water solubility. They increase biological oxygen demand, are highly toxic to aquatic organisms, and can be carcinogenic to man and animals.

The amounts of produced water produced from the oil industry around the world are enormous, and handling of produced water constitutes a great expense to the oil industry. Current methods for treating such produced water are cumbersome and expensive and in addition do not remove organic substances to a satisfactory degree. Historically, produced water was managed in the most convenient or least expensive ways. In many cases, especially at offshore facilities, produced water is simply discharged into the environment without treatment. However, such discharge is an environmental risk and is to be avoided. Today, many companies recognise that water may be either a cost or a value to their operations, and great attention to water management allows production of hydrocarbons and the concomitant profits to remain sustainable.

Today, according to industry guidelines (“Produced water white paper”, 2004, by John A. Veil, Markus G. Puder, Deborah Elcock and Robert J. Redweik, Jr., for U.S. Department of Energy National Energy Technology Laboratory Under Contract W-31-109-Eng-38), existing oil recovery facilities should meet a level of performance known as best available technology economically achievable (BAT) for toxic and unconventional pollutants.

In addition, produced water is increasingly seen as a resource. Especially produced water from onshore facilities being used for a number of purposes including livestock watering, irrigation of crops, wetland habitat production, aquaculture and hydroponics highlights that produced water may become a valuable resource. However, such potential use requires that the produced water is sufficiently purified in order to sustain environmental suitability.

Accordingly, there is a need in the art of producing produced water of a quality making it a resource for recycling uses.

There are methods described in prior art mainly relating to treatment of waste water. One such example is DE 4136616 which relates to purification of waste water as a pre-treatment prior to biological water treatment and purification. The method used therein requires the use of flocculants such as e.g. polymeric materials such as e.g. polyvinyl chloride, polyolefins, different types of starches etc. which may also require further addition of chemicals such as e.g. FeCl₃ to bring about coagulation like reaction of the polymer. It is in fact these flocculants that are responsible for capturing to contaminants, and e.g. CO₂ and Ca(HCO₃)₂ are merely used to regulate pH and to keep the pH above 8.7 in order not to hydrolyse the polymers used in the process.

At offshore oil recovery facilities, produced water treatment may be challenging because offshore facilities do not have abundant space or weight capacity for treatment equipment. In addition, offshore environments are remote and typically harsh, and equipment and processes operating there must be designed for those environments.

According to one known method of treating produced water, the produced water is first pre-treated by skimmers or other basic separation equipment to remove oil droplets greater than 100 microns in size. Devices for promoting coalescence of small oil droplets into larger droplets may also be used. Thereafter, the water receives primary treatment to remove additional free oil, e.g. by centrifugation. Thereafter, the produced water is treated to remove emulsified oil and suspended solids. Conventionally, this has been achieved by use of flotation cells, adsorption, ion exchange, filtration, and organic extraction.

However, these methods are cumbersome and expensive and often difficult to operate offshore. Additionally, these methods are not particularly efficient.

Accordingly, there is also a need in the art for simpler and more efficient methods of producing purified produced water that may be safely discharged into the environment, e.g. from offshore oil recovery facilities.

Further, water treatment technologies are often limited to treating specific constituent types concentrated in water, e.g. dissolved solids, organics, conductive ions, etc. Depending on the subsequent use of the water and the desired constituent concentrations, treatment processes are often coupled together to achieve required water use objectives.

Accordingly, there is a need in the art for methods of producing purified produced water, which can purify the water from several constituents in a simple process.

The purification method of the present invention overcomes these drawbacks in that it is simpler and more efficient than known technologies.

Further, the method may also provide additional benefits in that the simple constituents needed according to the method are more readily available and may even come from other waste products produced during oil recovery.

### DISCLOSURE OF THE INVENTION

Thus, it is an object of the present invention to provide a method for purification of produced water, e.g. from the oil industry, which is simpler and more efficient than the prior art methods in removing organic and/or bioaccumulative and/or toxic substances.

It is a second object of the present invention to provide a method for purification of produced water, e.g. from the oil industry, which is more efficient than the prior art methods for removing lipophilic substances.

It is a further object of the invention to provide a method for purification of produced water using readily available chemicals for the purification.

It is a further object of the invention to provide a method for purification of produced water using waste products from oil recovery facilities as chemicals for the purification.

It is a further object of the invention to provide a method for purification of produced water reducing the need for organic chemicals and/or reusing the chemicals needed for the purification.

It is a further object of the invention to provide a method for purification of produced water minimising the discharge of polluting material.

It is a further object of the invention to provide a method for purification of produced water that is cost-efficient and relatively simple.

It is a further object of the invention to provide a produced water product which can be safely discharged into the environment, e.g. on offshore locations.

It is a further object of the invention to provide a produced water product which can be used as a water resource, e.g. as a resource for purposes such as e.g. livestock watering, irrigation of crops, wetland habitat production, aquaculture and hydroponics.

It is a further object of the invention to provide a produced water product which can be reinjected into oil wells during recovery of oil.

Moreover, present method does not require addition of other flocculating agents, such as e.g. polymers of vinyl acetate (either homo- or co-polymers), polystyrene butadiene, polyvinyl alcohol (PVA), polyolefins, polyvinyl chloride, polyacrylates, polymethacrylates, epoxide-based polymers, starches, dextrins, hydroxyethyl cellulose (HEC), nonylphenol derivatives etc. This means that present invention has the advantage of good process economy and minimised environmental impact. Moreover, present invention does not require any addition of transition metals salts such as e.g. FeCl₃ or other metal salts that are considered harmful to the environment, such as e.g. aluminium salts of Arsenic salts. In contrast to prior art methods, present invention offers new possibilities for the purified produced water. For example, since present invention does not require the use of flocculants as commented upon above, the purified produced water can be pumped back directly into the oil well or be used for irrigation without any intermediate steps of removal of any residues or added components. In this respect, it should be noted that processes wherein flocculants are used to purify water are unsuitable to be used in the context of oil exploitation or for irrigation as any fractional remains of flocculants will effectively block microchannels and pores in rock material or earth material and thereby effectively preclude a further flux of water through the structure. Such characteristics render water purified by flocculation methods completely unsuitable for pumping back into oil wells or irrigation purposes as this will completely hinder any further water passage. In the context of oil wells, it is extremely important that water is allowed to pass through the structure wherein oil is extracted in order to allow further oil extraction of even the smallest remaining oil deposits or residues. In the context of irrigation, it is also vital to have a free flow of water in order to allow efficient watering and ground aeration of e.g. crop.

In the experimental process leading to the present invention, the inventor found that addition of lime or dissolved calcium hydroxide to the produced water followed by treatment allowing a precipitate of the lime to be formed in contact with the produced water, followed by removal of the precipitate, is very easily implementable and very efficient in purifying produced water.

The new and unique way in which one or more of the above objects are addressed is a method for purifying produced water comprising
a first step of providing and dissolving calcium hydroxide into the produced water,
a second step of subjecting the produced water comprising dissolved calcium hydroxide step to treatment for forming a calcium carbonate precipitate from the dissolved calcium in the produced water,
a third step of removing the precipitate from the produced water, thereby forming purified produced water.

In another aspect, and with reference to FIG. 1, the present invention relates to a system for carrying out the method of the present invention, the system comprising
a mixing vessel
a vessel comprising an aqueous composition comprising dissolved calcium hydroxide, said vessel being in fluid communication with the mixing vessel,
a supply of produced water being in fluid communication with the mixing vessel,
a supply of carbon dioxide in contact with the mixing vessel,
means for collecting and removing a precipitate from the mixing vessel,
means for discharge of purified produced water from the mixing vessel.

### BRIEF DESCRIPTION OF THE DRAWING(S)

The present invention will now be discussed in more details with reference to the drawings in which:

FIG. 1 illustrates the method and the system of the present invention.

FIG. 2 shows a schematic flow chart of one embodiment of the method and system of the present invention.

### DETAILED DESCRIPTION OF THE INVENTION

The system comprises a mixing vessel (1), a vessel (2) comprising an aqueous composition comprising dissolved calcium hydroxide, which is in fluid communication with the mixing vessel (1), a supply of produced water (3) in fluid communication with the mixing vessel (1), a supply of carbon dioxide (4) in contact with the mixing vessel, means for collecting and removing a precipitate from the mixing vessel (5), and means for discharge (6) of purified produced water from the mixing vessel.

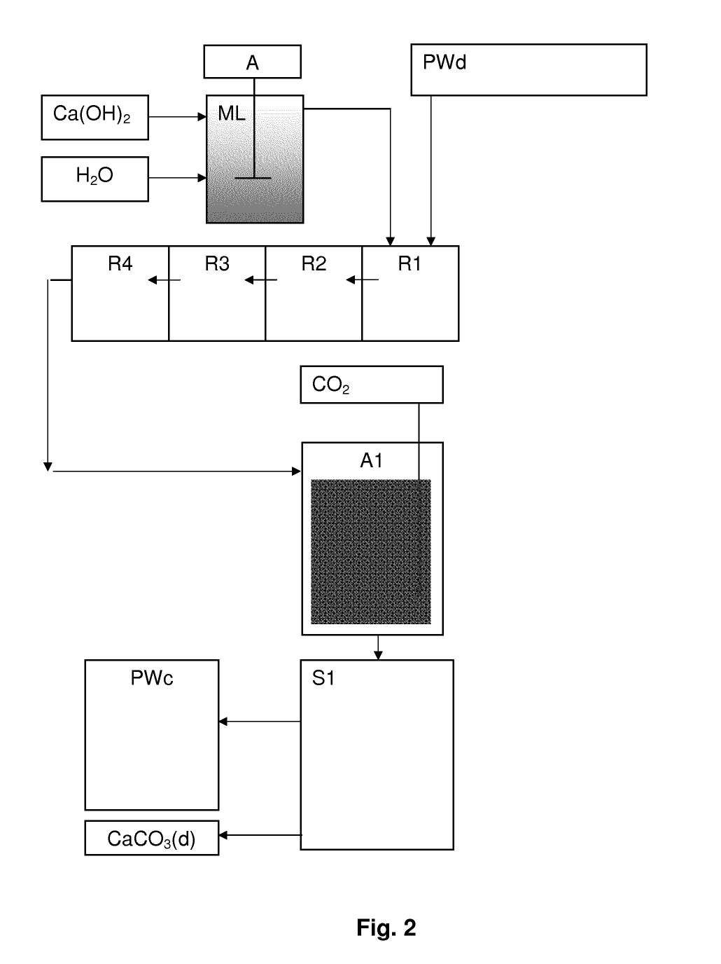

The system in FIG. 2 comprises a vessel comprising milk of lime (ML) under continuous agitation (A) in fluid communication with a mixing vessel comprising 5 individual mixing tanks (R1-R4 and A1) in fluid communication with each other. The mixing vessel comprises inlets for unpurified produced water (PWd) and inlets for calcium hydroxide suspensions/solutions. In the mixing vessel, the calcium hydroxide and the produced water are mixed, for example by stirring. The resulting solution/suspension of produced water comprising calcium hydroxide is directed from each mixing tank to the next by ordinary overflow and finally into a last mixing tank (A1), preferably by an ordinary overflow. In the last mixing tank, CO₂, e.g. in the form of flue gas is added to the produced water, e.g. by letting a gas flow of atmospheric air or flue gas flow through the suspension. The pH of the solution in the last mixing tank should be kept around neutral (pH 6-8).

The resulting solution/suspension is directed into the separation chamber (S1), preferably by an ordinary overflow, where the precipitate (CaCO₃) and the purified clean produced water (PWc) are collected.

In a first aspect, the present invention relates to a method for purifying produced water comprising;
a first step of providing and dissolving calcium hydroxide into the produced water,
a second step of subjecting the produced water comprising dissolved calcium hydroxide to a treatment that facilitates the formation of a calcium precipitate,
a third step of collecting and removing the precipitate from the produced water, thereby forming a purified produced water product.

The inventive method has surprisingly shown to be very efficient for removing contamination substances such as oily substances from the produced water from e.g. the petrochemical industry.

Surprisingly, the method is simpler and easier to implement than previously known purification methods although the purification is superior to the known methods. Preferably, the first step is carried out by producing a calcium hydroxide (Ca(OH)₂) solution/suspension, e.g. by addition of lime to water. Thereafter, this solution/suspension is added to the produced water. Preferably, according to the inventive method, the suspension of calcium hydroxide is produced by adding calcium oxide to water.

Calcium hydroxide is only sparsely soluble in water, with a solubility of approximately 1.5 g per litre at 25° C. Limewater is the common name for a sub saturated or saturated calcium hydroxide solution, whereas milk of lime is the common name for a suspension (supersaturated) of lime in water. While limewater is a clear solution, milk of lime is a suspension of calcium hydroxide particles in water (saturated with calcium hydroxide) giving it a milky appearance. Lime water and milk of lime is commonly produced by reacting calcium oxide (CaO or quicklime) with an excess of water—usually 4 to 8 times the amount of water to the amount of quicklime. Reacting water with quicklime is sometimes referred to as “slaking” the lime. Following addition of water, calcium oxide will convert to the hydroxide according to the following reaction scheme:

CaO+H₂O→Ca(OH)₂

The mixture needs to be shaken to ensure the solution is saturated with calcium hydroxide. Then, it is left to settle and the clear “saturated” solution (lime water) is collected. Milk of lime is an alkaline with a pH of 12.3. Lime water or milk of lime may also be produced by adding hydrated lime (Ca(OH)₂) to water.

Adding acid to lime water or milk of lime causes the calcium hydroxide to precipitate. The composition of the precipitate depends on the acid added. If the acid added is CO₂, the precipitate is CaCO₃.

Without being bound by any theory, it is believed that the method according to the present invention purifies the produced water by trapping the contaminating substances in the precipitate. Thus, upon precipitation of the calcium carbonate, small macro cavities are believed to be formed which entrap the contaminating substances in the produced water. It is also believed that it is the agglomeration of crystalline particles of the formed CaCO₃ in the process that is responsible for the capturing of contaminants.

It was found that the precipitate formed by adding CO₂ (precipitate calcium as calcium carbonate) was superior in purifying produced water. In addition to being superior in providing the superior precipitate calcium carbonate, CO₂ is readily available and may be provided by subjecting the produced water comprising dissolved calcium hydroxide to a stream of atmospheric air.

However, it was also surprisingly discovered that flue gas was an excellent source of carbon dioxide and that the quality of the purified produced water was not significantly affected by subjecting it to a stream of flue gas. On the contrary, the method according to the invention was surprisingly capable of purifying waste products in a single process. Accordingly, the supply of carbon dioxide by means of flue gas surprisingly provided a method capable of purifying both flue gas, e.g. emanating from the oil recovery process, and produced water.

Thereby, the method according to the invention surprisingly solves the problems of purifying produced water and of purifying flue gas in a single simple process which produces products readily dischargeable into the environment or useable as a resource for other purposes.

Importantly, when precipitating the dissolved calcium hydroxide in the produced water by use of CO₂ into CaCO₃, the pH value of the produced water should preferably be controlled such that the pH does not fall below pH 6.0 and should not exceed pH 8.0

At pH values below 6.0 (which may e.g. be obtained if excess CO₂ is added), the following reaction takes place: CaCO₃+H₂O+CO₂->Ca(HCO₃)₂. The formation of calcium bicarbonate is to be avoided as it is detrimental to the purification process.

Accordingly, when facilitating the precipitation of the dissolved calcium hydroxide in the produced water by addition of carbon dioxide the pH of the produced water must be above 6.0 and preferably, it should be kept at pH 7.0 or above. Preferably, the pH of the mix of calcium hydroxide in the produced water should be in the interval of about 5.5 to about 8.5, such as e.g. about 6.0 to about 8.0, such as e.g. about 6.5 to about 7.5, such as about e.g. 7.0 to about 8.0, such as about 6.0, such as about 7.0, such as about 7.5, such as about 8.0. Surprisingly, tt has been discovered that if the pH rises above about 8.0, the precipitation of calcium carbonate and subsequent agglomeration have an impaired property of entrapping the contaminating substances in the produced water.

Moreover, if the purified produced water has a pH of about 5.5 to about 8.5, such as e.g. about 6.0 to about 8.0, such as e.g. about 6.5 to about 7.5, such as about 7.0 to about 8.0, such as about 6.0, such as about 7.0, such as about 8.0, such water can be safely discharged into the environment without further adjustment of the pH. Preferably, the pH of the discharged purified produced water should have a pH of about 6.0 to about 7.0, such as e.g. about 6.0, such as about 6.5, such as about 7.0, such as e.g. about 7.5. This is particularly important in the cases were purified produced water is intended to be used for e.g. irrigation or simply to be let out into the ocean. The neutral pH (being in the range of about 6.0 to about 8.0) will ensure that no damages are done to the environment.

Surprisingly, it was observed that flue gas was surprisingly effective and useful as source of carbon dioxide as it was observed that even excessive addition thereof did not result in the pH to fall below 6. In the alternative, atmospheric air can be used.

Surprisingly, it was discovered that providing an excess of suspended calcium hydroxide to the produced water (e.g. by addition of excessive amounts of concentrated milk of lime) did not provide any significant improvement to the purification process compared to addition of lime in an amount that only corresponded to or was sufficient to provide a saturated solution of calcium carbonate in the produced water (and subsequent precipitation thereof).

Accordingly, and with the object of providing a simple process using a minimum of resources, in a preferred aspect of the invention, calcium hydroxide is provided to the produced water in an amount capable of providing a final concentration of 0.5-2.5 g/l, preferably 1.0-2.0 g/l, even more preferably approximately 1.5 g/l of calcium hydroxide in the produced water.

Further, it was observed that in some applications, it was of great importance to the performance of the purification process that the lime milk added to the produced water did not contain a concentration of calcium hydroxide being too great. Surprisingly, more dilute concentrations resulted in improved purification performance.

Accordingly, it is preferred according to the invention to provide calcium hydroxide to the produced water as a solution or suspension of between about 0.5% to about 30% by weight of calcium hydroxide in relation to water, such as e.g. about 1%-to about 25% by weight of calcium hydroxide in relation to water. Even more preferred is a suspension of between 0.5% to about 15%, such as e.g. 2%-25% by weight of calcium hydroxide, such as between 5-20%, such as between 10-15% lime.

In order to provide the best purification of the produced water, the calcium hydroxide should be allowed to fully dissolve in the produced water to form a near saturated or saturated solution.

One further advantage of present invention is that the produced water to be purified does not need any pre-treatment. This is particularly advantageous in the context of offshore oil drilling, wherein the water has a saline content of about 3.1 to about 3.8%. The content of salt does not affect the precipitation/agglomeration of CaCO₃ according to present invention.

Another advantage of present invention is that the purified process water can be recycled wholly or partly to the process of dissolving calcium hydroxide.

In order to ease the dissolution of calcium hydroxide in the produced water, the addition of calcium hydroxide should preferably be done with extensive mixing.

Surprisingly, during precipitation of the dissolved calcium as calcium carbonate, the contaminating substances, such as crude oil, are removed to an unprecedented degree from the produced water.

The precipitate containing the contaminants may then be removed from the produced water by means of conventional separation tanks, wherein the precipitate settles due to gravitational forces whereupon the purified produced water can be isolated.

However, due to large amounts of water having to be handled at oil recovery facilities, it was found that isolation of the calcium precipitate by a centrifuge was significantly more time efficient. Accordingly, the separation of the precipitate from the produced water is preferably obtained from use of centrifuges.

The method according to the invention may be performed on any produced water, just as any produced water originating from offshore and onshore locations can be purified according to the invention.

However, the inventive method has been shown to be superior to known methods especially when purifying produced water having a high content of oil. Such produced water often originates from “old” wells, where the previous oil recovery and reintroduction of produced water to the well have produced a significant mixing of oil and water in the well. Wells, in which oil and water have been allowed to mix for long periods of time, are other examples of wells producing produced water with high oil content. Examples thereof are some oil fields in Canada where extensive amounts of water in the oil are estimated to produce so much produced water and corresponding lower amounts of oil that it is difficult to contemplate economically viable oil recovery.

According to one embodiment, the method is carried out onshore. This includes treating produced water with the inventive method in the context of onshore oil and gas exploration, drilling, production operations and/or refining operations.

Due to the simplicity of the method and the readily available constituents (carbon oxide, water and CO₂), the method according to the invention is readily suitable for offshore oil recovery facilities. Further, the surprising ability of the method to use and purify flue gas, e.g. from the oil recovery process, makes the inventive method a superior choice for a purification process implemented offshore.

According to another embodiment, the method is carried out offshore. As used herein, the term “offshore” refers to the method being carried out at sea as opposed to on land.

Increasingly, purified (or substantially pure) water is valued also as a resource. The purified produced water according to the invention is remarkably and unprecedentedly pure. Accordingly, the present invention is also directed at purified produced water obtainable by the use of the inventive method. Such purified water has many applications, such as e.g. livestock watering, irrigation of crops, wetland habitat production, aquaculture and hydroponics. Accordingly, the invention also relates to purified produced water as such obtainable according to the inventive method having the further characteristics of originating from oil deposits.

In addition, the produced water purified according to the invention may be safely discharged into the environment. This is an essential element of the implementation of the invention, e.g. at offshore facilities, where the safe discharge of purified produced water has not been possible until the present invention.

Accordingly, the invention also relates to purified produced water as such obtainable according to the inventive method having the further characteristics of originating from oil deposits and the characteristic of being present at oil recovery facilities, such as offshore oil recovery facilities.

According to the invention is has for the first time been proven possible to obtain a produced water product wherein the presence of hydrocarbons has been almost eliminated.

Accordingly, in one aspect, the invention relates to a purified produced water product comprising traces of hydrocarbon substances in an amount of between 1 μg/l to less than 15000 μg/l, measured as the sum of the content of benzene-C₃₅ substances using the method of analysis according to ISO 9377-2.

The method ISO 9377-2 is used to measure hydrocarbon substances having a boiling point of 70° C.-490° C. and is used regularly to measure oil substances originating from crude oil. In general and when referring to amounts of hydrocarbon substances, reference is made to amounts measured using ISO 9377-2 (EN ISO 93377-2:2001) throughout the present application. This method was also used in the example shown below.

Preferably, the purified produced water product will contain traces of hydrocarbon substances in an amount of less than 10000 μg/l, measured as the sum of the content of benzene-C₃₅ substances. Even more preferably, the purified produced water will contain traces of hydrocarbon substances in an amount of less than 5000 μg/l, measured as the sum of the content of benzene-C₃₅ substances using ISO 9377-2. Even more preferably, the purified produced water will contain traces of hydrocarbon substances in an amount of less than 2000 μg/l, measured as the sum of the content of benzene-C₃₅ substances using ISO 9377-2. Even more preferably, the purified produced water will contain traces of hydrocarbon substances in an amount of less than 1000 μg/l, measured as the sum of the content of benzene-C₃₅ substances using ISO 9377-2. Even more preferably, the purified produced water will contain traces of hydrocarbon substances in an amount of less than 500 μg/l, measured as the sum of the content of benzene-C₃₅ substances using ISO 9377-2.

In practice, the complete removal of traces of hydrocarbons from the purified produced water is impossible using the present invention. Further, the increased purity obtainable by performing the method several times on the same sample must be balanced against the reduction thereby obtainable, which also diminished with increased purity of input sample. Thus, the purified produced water according to the invention will contain traces of hydrocarbon substances in an amount of more than 1 μg/l, measured as the sum of the content of benzene-C₃₅ substances using ISO 9377-2. Even more preferably, the purified produced water will contain traces of hydrocarbon substances in an amount of more than 10 μg/l, measured as the sum of the content of benzene-C₃₅ substances using ISO 9377-2. Even more preferably, the purified produced water will contain traces of hydrocarbon substances in an amount of more than 50 μg/l, measured as the sum of the content of benzene-C₃₅ substances using ISO 9377-2. Even more preferably, the purified produced water will contain traces of hydrocarbon substances in an amount of more than 100 μg/l measured as the sum of the content of benzene-C₃₅ substances using ISO 9377-2. Even more preferably, the purified produced water will contain traces of hydrocarbon substances in an amount of more than 250 μg/l, measured as the sum of the content of benzene-C₃₅ substances using ISO 9377-2. Alternatively, and using the ISO 9377-2 standard, the sum of the content of benzene-C₃₅ substances should be less than e.g. about 1500 μg/l, such as e.g. less than about 1000 μg/l, such as e.g. less than about 750 μg/l, such as e.g. less than about 600 μg/l, such as e.g. less than about 550 μg/l, such as e.g. less than about 450 μg/l, such as e.g. less than about 350 μg/l, such as e.g. less than about 250 μg/l, such as e.g. less than about 100 μg/l, such as e.g. less than about 50 μg/l, such as e.g. less than about 25 μg/l, such as e.g. less than about 10 μg/l, such as e.g. less than about 5 μg/l, such as e.g. less than about 1 μg/l. It should be clearly understood that the lower limit of these substances is the detection level which may be about 0.1 μg/l, about 0.5 μg/l, about 1.0 μg/l, about 2 μg/l, about 5 μg/l or about 10 μg/l.

This product will also contain traces of other constituents normally found in produced water, i.e. it will at least contain traces of one or more of the compounds Lead (Pb), Cadmium (Cd), Chrome (Cr), Copper (Cu), Mercury (Hg), Nickel (Ni) and Zinc (Zn).

Typically, the amounts of Lead (Pb), Cadmium (Cd), Chrome (Cr), Copper (Cu), Mercury (Hg), Nickel (Ni) and Zinc (Zn) are in the range of approx. 0.1-5 μg/l of each compound. After purification according to the invention, the content of the compounds in the produced water product diminishes significantly, although a complete removal of the compounds cannot be obtained.

This product may also be particularly suited for reinjection purposes, where produced water is re-injected into oil deposits during recovery of oil.

In one embodiment, the invention relates to an oil recovery facility comprising the purified produced water product. In one embodiment, the invention relates to a water purification system comprising the purified produced water product. In one embodiment, the invention relates to an oil recovery facility comprising a water purification system comprising the purified produced water product. In one embodiment, the oil recovery facility is an off-shore facility. In another embodiment, the oil recovery facility is an on-shore facility.

The invention also relates to a system for carrying out the method according to the invention.

The inventive system comprises
a mixing vessel (1),
a vessel (2) comprising an aqueous composition comprising dissolved calcium hydroxide, said vessel being in fluid communication with the mixing vessel (1),
a supply of produced water (3) being in fluid communication with the mixing vessel (1),
a supply of carbon dioxide (4) in contact with the mixing vessel,
means for collecting and removing a precipitate from the mixing vessel (5),
means for discharge (6) of purified produced water from the mixing vessel.

Preferably, the mixing vessel comprises a first mixing tank for mixing produced water and milk of lime, and in fluid communication therewith, a separate second mixing tank for mixing the produced water comprising dissolved calcium hydroxide with CO₂.

Preferably, the first mixing tank comprises two or more mixing tanks in fluid communication with each other. Preferable, the first mixing tank comprises three or four mixing tanks in fluid communication with each other. Preferably, the fluid communication is plug-flow. Thereby, an increased control and an increased efficiency is obtained.

Preferably, the vessels for supply of calcium hydroxide and the mixing vessels comprise means for agitation of the aqueous solutions/suspensions contained therein.

Preferably, the means for collecting and removing the precipitate from the mixing vessel comprises a separation chamber for gravity separation or a centrifuge.

The invention also relates to the use of the above system and method for purifying produced water directly at the oil recovery facility. In one aspect, the use is carried out on site at offshore oil recovery facilities. Accordingly, the invention also relates to offshore oil recovery facilities comprising the system of the invention. In another aspect, the use is carried out on site at onshore oil recovery facilities. Accordingly, the invention also relates to onshore oil recovery facilities comprising the system of the invention.

### EXAMPLES

In the following examples, the invention is illustrated. The purpose of the examples is merely illustrative and should not be considered limited.

In the examples herein, ISO 9377-2 is used as analysis method. According to this standard, the content of hydrocarbons is measured. Analysis of the contents of hydrocarbons is performed by gas chromatography (GC) with a flame ionization detection (FID). Typically, the injection technique is programmed temperature vaporization (PTV) with injection temperature 50° C. to 300° C., with an injection volume of 1 μl. Column length is 30 m with an internal diameter of 0.25 mm. The liquid phase is DB 5 MS. Film thickness 0.25 μm. The pre-column is deactivated fused silica capillary. Carries gas: hydrogen at a pressure of 0.8 bar. Oven temperature programme; 40° C. for 5 min, 10° C./min to 300° C., 300° C. for 20 min. Detector temperature 300° C. Make-up gas: nitrogen with a flow of 25 ml. Internal standard; n-decane and n-tetracontane.

### Example 1

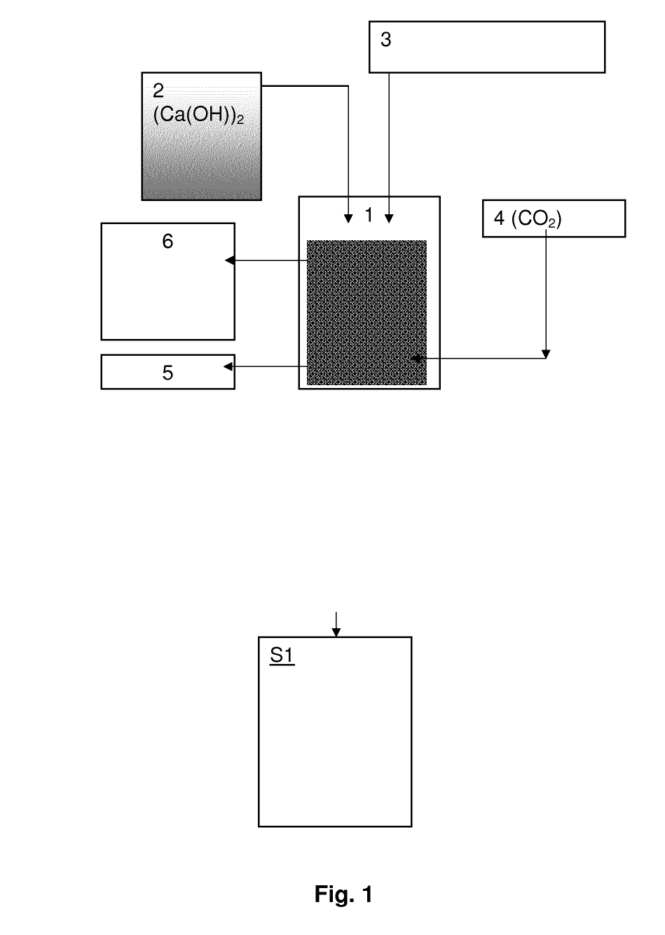

An exemplary process of purifying the produced water according to the invention is illustrated schematically in FIG. 1.

Milk of lime (ML) was produced in a large tank (or vessel) by adding 1 part (by weight) hydrated lime (Ca(OH)₂) to 10 parts (by weight) water under continuous agitation (A).

The lime (Ca(OH)₂) was only diluted partly, but the constant agitation ensured that undiluted lime was kept suspended in the liquid (ML). The top phase of the liquid in the tank contained the small lime particles, whereas larger particles had a tendency to sediment. Large sedimenting particles of lime (Ca(OH)₂), however, disintegrated on contact with the agitation paddles near the bottom of the tank.

A continuous flow of milk of lime was provided to a separate first mixing tank (R1) from the top phase of the tank containing the milk of lime in order to provide a milk of lime having a small lime particle size.

In addition, the first mixing tank was provided with a continuous flow of produced water containing contaminating substances (PWd).

The amount of lime added corresponded to a concentration of lime in the produced water in the mixing tank of approximately 1.5 g/l.

From the first mixing tank, the top phase of the liquid was transferred by plug-flow to a second mixing tank (R2), and further to a third (R3) and a fourth mixing tank (R4).

The liquid in the mixing tanks was kept under constant agitation. The formation of an agglomerate was observed in the mixing tanks.

From the fourth mixing tank, a flow of produced water containing calcium hydroxide was introduced into a separate mixing tank, an aerator tank (A1), where the liquid was aerated by blowing CO₂-containing flue gas through the liquid. The formation of a CaCO₃ precipitate was observed rapidly. The produced water was aerated to such extend that the pH of the liquid reached neutral (pH=7).

The liquid was then transferred to a sedimentation tank (S1), and the precipitate was sedimented and removed (P2) from the purified produced water (PWc). The cleaned produced water was observed to be purified to such an extent that it could be discharged into the environment without further concern (see data below).

Several samples of produced water obtained from Maersk Oil and Gas were purified according to the procedure described above. These samples were analysed for content of hydrocarbons by the analytical laboratory Eurof ins Miljø A/S, Ladelundvej 85, 6600 Vejen. Sample 1 shown below represented a sample of produced water containing relatively high initial amounts of hydrocarbons, whereas sample 2 represent a sample of produced water containing a relatively low initial content of hydrocarbons.

### Sample 1 (Before Purification According to the Invention):

| Hydrocarbon | | | |
|---|---|---|---|
| fractions | Results (μg/l) | Limit of detection | Method |
| Benzene-C10 | 1300 | 2.0 | I9377-2m GC/FID |
| C10-C25 | 91000 | 8.0 | I9377-2m GC/FID |
| C25-C35 | 49000 | 10.0 | I9377-2m GC/FID |
| Sum (benzene- | 140000 | | I9377-2m GC/FID |
| C35) | | | |

Sample 1 (after Purification According to the Invention):

| Hydrocarbon | | | |
|---|---|---|---|
| fractions | Results (μg/l) | Limit of detection | Method |
| Benzene-C10 | 19 | 2.0 | I9377-2m GC/FID |
| C10-C25 | 400 | 8.0 | I9377-2m GC/FID |
| C25-C35 | 140 | 10.0 | I9377-2m GC/FID |
| Sum (benzene- | 560 | | I9377-2m GC/FID |
| C35) | | | |

### Sample 2 (Before Purification According to the Invention):

| Hydrocarbon | | | |
|---|---|---|---|
| fractions | Results (μg/l) | Limit of detection | Method |
| Benzene-C10 | 7400 | 2.0 | I9377-2m GC/FID |
| C10-C25 | 19000 | 8.0 | I9377-2m GC/FID |
| C25-C35 | 6600 | 10.0 | I9377-2m GC/FID |
| Sum (benzene- | 33000 | | I9377-2m GC/FID |
| C35) | | | |

Sample 2 (after Purification According to the Invention):

| Hydrocarbon | | | |
|---|---|---|---|
| fractions | Results (μg/l) | Limit of detection | Method |
| Benzene-C10 | 110 | 2.0 | I9377-2m GC/FID |
| C10-C25 | 290 | 8.0 | I9377-2m GC/FID |
| C25-C35 | 45 | 10.0 | I9377-2m GC/FID |
| Sum (benzene- | 450 | | I9377-2m GC/FID |
| C35) | | | |

Purifying the produced water in one extra purification process according to the invention resulted in a reduction of the content of hydrocarbons. However, in practice it was not possible to obtain a total removal of all traces of hydrocarbons.

The purification process also resulted in a significant reduction of the content in the produced water of several undesired metal compounds such as Lead (Pb), Cadmium (Cd), Chrome (Cr), Copper (Cu), Mercury (Hg), Nickel (Ni) and Zinc (Zn). However, in practice it was not possible to obtain a total removal of all traces of metals.

Sample 3 (after 2 rounds of purification according to the invention):

| Hydrocarbon | | | |
|---|---|---|---|
| fractions | Results (μg/l) | Limit of detection | Method |
| Benzene-C10 | 51 | 2.0 | I9377-2m GC/FID |
| C10-C25 | 300 | 8.0 | I9377-2m GC/FID |
| C25-C35 | 17 | 10.0 | I9377-2m GC/FID |
| Sum (benzene- | 370 | | I9377-2m GC/FID |
| C35) | | | |

### Example 2

The method according to the invention was tested with respect to ability to purify produced water from heavy metals. After the same purification method as described in Example 1 and using the analysis method of ISO 17294 and using inductively coupled plasma mass spectrometry (ICPMS) for detection of the heavy metals. For all metals tested, the reduction in the presence of heavy metal was remarkably low after purification by the method of present invention and a seen in the table below.

| Metal | Before purification (μg/l) | After purification (μg/l) |
|---|---|---|
| Lead (Pb) | 0.6 | <0.5 |
| Cadmium (Cd) | 2.2 | 0.10 |
| Chromium (Cr) | 3.6 | 0.7 |
| Copper (Cu) | 2.1 | <1.0 |
| Mercury (Hg) | 0.42 | <0.050 |

1. A method for purifying produced water comprising;
a first step of providing and dissolving calcium hydroxide into the produced water,
a second step of subjecting the produced water comprising dissolved calcium hydroxide to a treatment that facilitates the formation of a calcium carbonate precipitate,
a third step of collecting and removing the precipitate from the produced water, thereby forming a purified produced water product.

2. A method according to claim 1, wherein the second step comprises addition of carbon dioxide to the produced water comprising dissolved calcium hydroxide.

3. A method according to claim 2, wherein the carbon dioxide is added by leading a stream of flue gas through the produced water comprising dissolved calcium hydroxide.

4. A method according to any of the previous claims, wherein calcium hydroxide is provided in the first step in an amount providing a final concentration of 0.5-2.5 g/l, preferably 1.0-2.0 g/l, even more preferably approximately 1.5 g/l of calcium hydroxide in the produced water.

5. A method according to any of the preceding claims, wherein calcium hydroxide is provided in the first step as a suspension comprising between 1%-25% by weight of calcium hydroxide in water.

6. A method according to claim 5, wherein calcium hydroxide is provided as a suspension comprising between 5%-20% by weight of calcium hydroxide in water.

7. A method according to claim 6, wherein calcium hydroxide is provided as a suspension comprising between 10%-15% by weight of calcium hydroxide.

8. A method according to any of the preceding claims, wherein the third step is carried out by gravity separation.

9. A method according to any of the preceding claims, wherein the third step is carried out by centrifugation.

10. A method according to any of the preceding claims, wherein the produced water originates from offshore oil recovery.

11. A method according to any of the preceding claims, wherein the method is carried out offshore.

12. A method according to any of the preceding claims, wherein the pH value of the produced water in the second step of claim 1 is controlled such that the pH does not fall below about pH 6.0 and does not exceed about pH 8.0

13. A method according to any of the preceding claims, wherein the produced water is not chemically pre-treated prior to the method of any of the preceding claims, but used as is.

14. A method according to any of the preceding claims, wherein the method does not include the use of flocculants such as e.g. polymers of vinyl acetate (either homo- or co-polymers), polystyrene butadiene, polyvinyl alcohol (PVA), polyolefins, polyvinyl chloride, polyacrylates, polymethacrylates, epoxide based polymers, starches, dextrins, hydroxyethyl cellulose (HEC), nonylphenol derivatives and/or colloidal solutions and/or further addition of transition metal salts such as e.g. FeCl₃ or other metal salts that are considered harmful to the environment such as e.g. aluminium salts of arsenic salts.

15. A method according to any of the preceding claims, wherein the purified produced water is recycled wholly or partly into the process of preparing calcium hydroxide solutions.

16. Purified produced water product comprising traces of one or more of the following metals; Lead (Pb), Cadmium (Cd), Chrome (Cr), Copper (Cu), Mercury (Hg), Nickel (Ni) and Zinc (Zn) and further comprising traces of hydrocarbon substances in an amount of 1 μg/l to less than 15,000 μg/l measured as the sum of the content of benzene-C₃₅ substances.

17. Purified produced water product, characterised by being obtainable by the method according to any of the preceding claims 1-16.

18. Oil recovery facility comprising purified produced water according to any of claim 16 or 17.

19. A system for carrying out the method of any of claims 1-16 comprising
a mixing vessel (1),
a vessel (2) comprising an aqueous composition comprising dissolved calcium hydroxide, said vessel being in fluid communication with the mixing vessel (1),
a supply of produced water (3) being in fluid communication with the mixing vessel (1),
a supply of carbon dioxide (4) in contact with the mixing vessel,
means for collecting and removing a precipitate from the mixing vessel (5),
means for discharge (6) of purified produced water from the mixing vessel.

20. A system according to claim 19, wherein the means for collecting and removing a precipitate from the mixing vessel (1) comprises a separation chamber for gravity separation or a centrifuge.

21. An offshore oil recovery plant comprising a system according to claim 19 or 20.

22. An onshore oil recovery plant comprising a system according to claim 19 or 20.
